(19) United States
(12) Patent Application Publication
(10) Pub. No.: US 2015/0163868 A1
(43) Pub. Date: Jun. 11, 2015

(54) LIGHT-EMITTING DIODE LIGHTING DEVICE HAVING MEANS FOR CONTROLLING THE ELECTRICAL POWER SUPPLY AND THE LIGHT SOURCE

(71) Applicant: LUCIBEL SA, Rueil Malmaison (FR)

(72) Inventor: Jean-Laurent Houot, Saint Clair de la Tour (FR)

(21) Appl. No.: 14/352,284

(22) PCT Filed: Oct. 16, 2012
(86) PCT No.: PCT/FR2012/052354

§ 371 Date: Apr. 16, 2014

(30) Foreign Application Priority Data
Oct. 17, 2011 (FR) 11/59381

(51) Int. Cl. H05B 33/08; F21V 29/70

(52) U.S. Cl. CPC H05B 33/0806; H05B 33/0842; F21V 29/70

(57) ABSTRACT

The device according to the invention includes (i) at least one light-emitting diode lamp (2) including at least one light-emitting diode light source, a heat dissipater (5) enabling the heat produced during operation of the light-emitting diode light source(s) to be evacuated, (ii) an electrical power supply that includes in particular a transformer and is intended to be connected to an electrical network in order to power the light-emitting diode light source(s). The device further includes means for controlling the operation of the electrical power supply and the light source, including an indicator light (9) powered by the electrical power supply and electrically connected to the electrical power supply in parallel with the light-emitting diode light source(s), the indicator light (9) being located on each light-emitting diode lamp (2).

### TECHNICAL FIELD

The present invention relates to a light-emitting diode lighting device.

### BACKGROUND

The light-emitting diode lamps have experienced a significant expansion in the last few years. This expansion is due to the advantages of these lamps compared to known incandescent or fluorescent lamps. Among these advantages, their lower energy consumption, their good mechanical strength or even their significantly longer service life can be cited.

As a result of this increased service life of the light-emitting diode lamps compared to the other types of lamps, the electrical power supply of the light-emitting diode lamps generally tends to fail before the light-emitting diode(s) forming the light source.

When a light-emitting diode lamp abnormally stops emitting, the problem of determining the cause of the failure arises. Given the long service life of the light-emitting diode lamps, it is often necessary to control the operation of the electrical power supply of these lamps. However, the electrical power supply of light-emitting diode lamps can be difficult to access, which makes the control of the operation thereof impractical.

### BRIEF SUMMARY

Therefore, the present invention aims to overcome all or some of these drawbacks by providing a light-emitting diode lighting device enabling to easily control the operation of the electrical power supply in order to determine the cause of a faulty operation of the device, without necessarily having to access to the electrical power supply.

To this end, the present invention relates to a light-emitting diode lighting device comprising:

(i) at least one light-emitting diode lamp comprising at least one light-emitting diode forming a light source, a heat sink enabling the heat generated during the operation of the light-emitting diode(s) forming the light source to be evacuated,

(ii) an electrical power supply comprising in particular a transformer and intended to be connected to an electrical network in order to power the light-emitting diode(s) forming the light source,

characterized in that the device further comprises means for controlling the operation of the electrical power supply and the light source, comprising an indicator light intended to be powered by the electrical power supply and electrically connected to the electrical power supply in parallel with the light-emitting diode(s) forming the light source, the indicator light being located on each light-emitting diode lamp.

Thus, the invention makes it possible to easily control the operating state of the electrical power supply, without the need to access this electrical power supply. The means for controlling the operation of the electrical power supply are in fact located on the light-emitting diode lamp and are, as a result, easily accessible to anyone desiring to control the operation of the electrical power supply. It is sufficient to dismount the light-emitting diode lamp from the support to which it is attached, like most electrical light bulbs, to access these controlling means. Controlling the operation of the electrical power supply is performed visually, through a simple glance, since the controlling means comprise an indicator light. This indicator light being powered by the electrical power supply, a link can be directly established by the user between the operation of the electrical power supply and the illumination of this indicator light or not.

According to another feature of the light-emitting diode lighting device according to the invention, the controlling means are located at the back of the heat sink.

A person desiring to control the operation of the electrical power supply only has to dismount the light-emitting diode lamp from its support and reverse it to have direct access to the controlling means. Moreover, when the light-emitting diode lamp is in place to illuminate a room (for example), the controlling means are advantageously not visible due to this location.

Advantageously, the indicator light is a light-emitting diode.

Advantageously, the controlling means also comprise a driving member adapted to close an electrical circuit comprising the electrical power supply and the indicator light when the driving member is actuated, in order to enable the illumination of the indicator light where applicable.

The driving member may be a push button cooperating with a switch.

When the push button is depressed by a user, the push button activates a switch closing the electrical loop comprising the electrical power supply and the indicator light. Thus, if the electrical power supply is operating, the indicator light illuminates. Hence, this means that the cause of the failure comes from the light-emitting diode lamp. By contrast, in the hypothesis where the electrical power supply is faulty, the indicator light does not illuminate. The light-emitting diode lamp is cleared from being the cause of the failure.

### BRIEF DESCRIPTION OF THE DRAWINGS

The aims, aspects and advantages of the present invention will be better understood according to the detailed description given hereinafter of one embodiment, given by way of non-limiting example, with reference to the accompanying drawings in which:

FIG. 1 is a perspective view of the front portion of a light-emitting diode lamp of a device according to one embodiment of the invention,

FIG. 2 is a perspective view of the rear portion of a light-emitting diode lamp of a device according to a particular embodiment of the present invention,

FIG. 3 is a view showing an electrical circuit of a device according to one embodiment of the invention.

### DETAILED DESCRIPTION

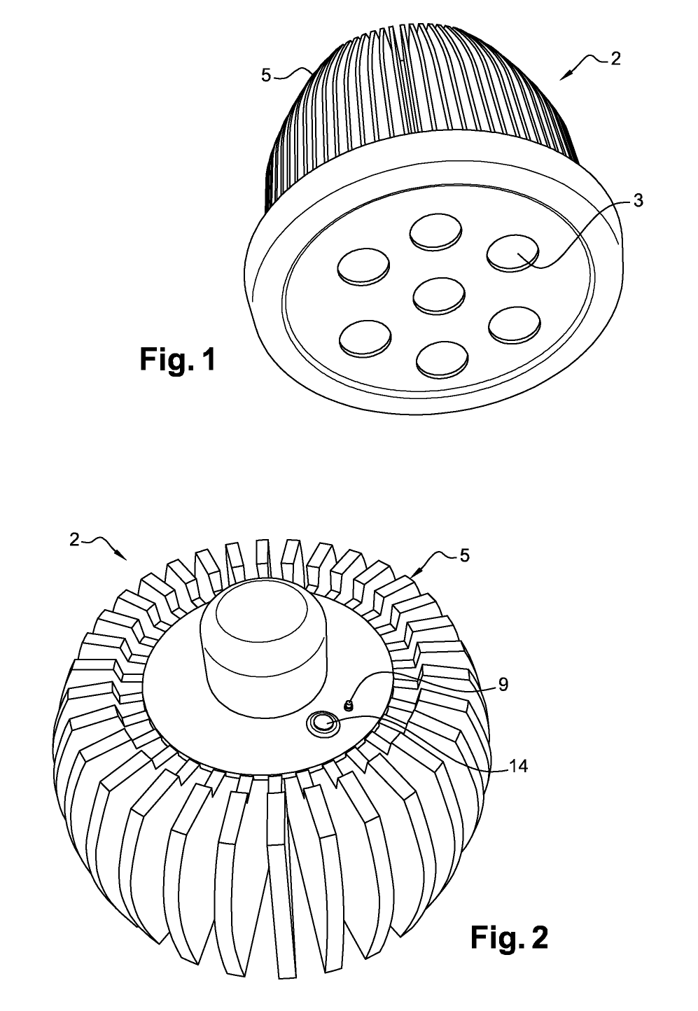

FIG. 1 shows the front portion of a light-emitting diode lamp 2 intended to equip a light-emitting diode lighting device 1 according to the invention. The lamp 2 comprises in particular a plurality of light-emitting diodes 3 forming a light source, which enables to illuminate a room for example. The light-emitting diode lamp 2 also comprises a heat sink 5 enabling the heat generated during the operation of the lamp 2 to be evacuated, when the light-emitting diode(s) emit light.

FIG. 2 shows the rear portion of the light-emitting diode lamp 2.

The lighting device 1 also comprises an electrical power supply 7. The electrical power supply 7 is intended to be connected to an electrical network (not shown) in order to power the light-emitting diode(s) 3 forming the light source. This may be the electrical network of the room wherein the device 1 is found. The electrical power supply 7 comprises in particular a transformer. It may also comprise a current source in order to control the current supplied to the light-emitting diode(s) 2.

The light-emitting diode(s) 3 forming the light source may be high powered, i.e. of a power higher than 1 Watt.

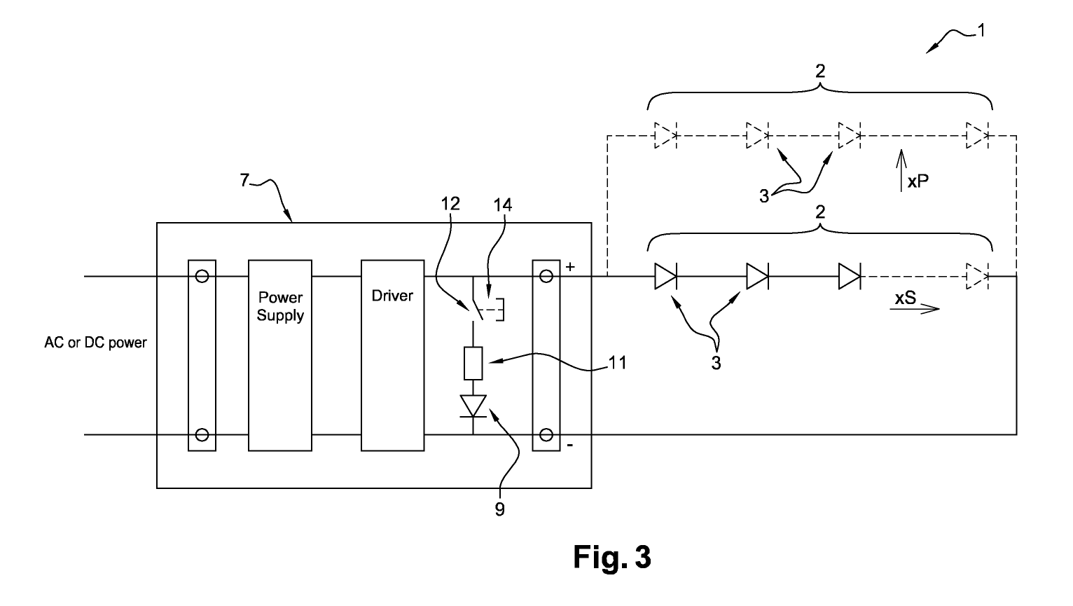

In a fully advantageous way, the device 1 comprises means for controlling the operating state of the electrical power supply 7. In the embodiment shown in FIGS. 2 and 3, these controlling means comprise an indicator light 9. The indicator light 9 is integral with the light-emitting diode lamp 2. It may be advantageously located at the back of the heat sink 5, as it can be seen in FIG. 2.

The indicator light 9 may be a light-emitting diode, as shown in FIG. 3. Where applicable, it may be a low-powered light-emitting diode, i.e. of a power lower than 1 Watt.

The indicator light 9 is powered by the electrical power supply 7. The indicator light 9 is connected in parallel with the light-emitting diode(s) 3 forming the light source. The indicator light 9 is therefore connected in parallel with the light-emitting diode lamp(s) 2.

FIG. 3 shows an electrical circuit of power supply of the lamp(s) 2 included in the device 1. The light-emitting diodes 3 of each lamp 2 are connected in series. In the example of FIG. 3, a series of light-emitting diodes 2 of a first lamp 2 is shown in dotted lines, said series being connected in parallel with the series of light-emitting diodes 2 shown in solid lines and forming a light source of a second lamp 2. FIG. 3 is a diagram showing the operation of the device 1; the indicator light 9 is advantageously positioned at the back of each light-emitting diode lamp 2.

The electrical circuit comprises the indicator light 9. It is also provided with an electrical resistor 11 connected in series with the indicator light 9 and provided with a switch 12, also connected in series with the indicator light 9.

The controlling means advantageously comprise a driving member, for example a push button 14, enabling to maintain the switch 12 in closed position when this driving member is activated (for example when the push button 14 is depressed by a user). The switch 12 is maintained in an open position when the driving member is deactivated. The push button 14 may be located at the back of the heat sink 5, close to the indicator light 9, as it can be seen in FIG. 2.

During operation, the light-emitting diode lighting device 1 according to the invention enables to easily control the operating state of the electrical power supply 7, without the need to access this electrical power supply 7. When a lamp 2 of the device 1 abnormally stops emitting light, a user only has to dismount this light-emitting diode lamp 2 from the support to which it is attached, to reverse it to visualize the rear portion thereof where the indicator light 9 is located, and to press the push button 14. If the indicator light 9 illuminates, this means that it is powered, and consequently that the electrical power supply 7 is operating. In this case, the user can conclude that the lamp 2 is the one which is faulty. By contrast, if the indicator light 9 does not illuminate when the push button 14 is depressed, this means that the electrical power supply 7 is faulty and that it should be repaired or replaced. With a light-emitting diode lighting device 1 according to the invention, the cause of a failure can thus be easily identified by a user, without the latter requiring to access the electrical power supply 7 to this end, which is often more difficult to access than the light-emitting diode lamps 2.

Although the invention has been described in connection with particular embodiments, it is quite obvious that it is in no way limited thereto and that it encompasses all the technical equivalents of the described means as well as the combinations thereof, if the latter fall within the scope of the invention.

1. A light-emitting diode lighting device comprising:
(i) at least one light-emitting diode lamp comprising at least one light-emitting diode forming a light source, a heat sink enabling the heat generated during the operation of the light-emitting diode(s) forming the light source to be evacuated,
(ii) an electrical power supply comprising in particular a transformer and intended to be connected to an electrical network in order to power the light-emitting diode(s) forming the light source, and
means for controlling the operation of the electrical power supply and the light source, comprising an indicator light intended to be powered by the electrical power supply and electrically connected to the electrical power supply in parallel with the light-emitting diode(s) forming the light source, the indicator light being located on each light-emitting diode lamp.

2. The light-emitting diode lighting device according to claim 1, wherein the controlling means are located at the back of the heat sink.

3. The light-emitting diode lighting device according to claim 1, wherein the indicator light is a light-emitting diode.

4. The light-emitting diode lighting device according to claim 1, wherein the controlling means also comprise a driving member adapted to close an electrical circuit comprising the electrical power supply and the indicator light when the driving member is actuated, in order to enable the illumination of the indicator light where applicable.

5. The light-emitting diode lighting device according to claim 4, wherein the driving member is a push button cooperating with a switch.
